(19) United States
(12) Patent Application Publication
(10) Pub. No.: US 2005/0116642 A1
(43) Pub. Date: Jun. 2, 2005

(54) Plasma display panel and method of manufacturing the same

(76) Inventors: Cheol-Hee Moon, Suwon-si (KR); Seung-Heon Oh, Suwon-si (KR); Young-Hwa Song, Suwon-si (KR)

Correspondence Address: Robert E. Bushnell;Suite 300, 1522 K Street, N.W., Washington, DC, 20005, US

(21) Appl. No.: 10/992,330

(22) Filed: Nov. 19, 2004

(30) Foreign Application Priority Data
Nov. 29, 2003 (KR) 10-2003-0086112

(51) Int. Cl. H01J 17/49

(52) U.S. Cl. 313/582

(57) ABSTRACT

In a method of manufacturing a plasma display panel (PDP) and in a PDP manufactured by that method, electrodes are formed on a panel substrate using an offset printing technique. Furthermore, in the method, a gravure groove having a predetermined pattern is filled with a nonconductive opaque-colored paste. The nonconductive opaque-colored paste is transcribed from the gravure groove onto a first substrate via a printing blanket such that the paste is targeted at a non-discharge region between adjacent transparent electrodes. Similarly, a bus electrode paste is transcribed onto the transparent electrodes. The paste patterns are dried and fired. A dielectric layer is formed on the patterns, thereby completing a front substrate. A rear substrate is aligned with the front substrate, and a discharge gas is injected between the substrates, followed by sealing of the substrates to each other.

### CLAIM OF PRIORITY

This application makes reference to, incorporates the same herein, and claims all benefits accruing under 35 U.S.C. § 119 from an application entitled PLASMA DISPLAY PANEL AND METHOD OF MANUFACTURING THE SAME filed with the Korean Intellectual Property Office on 29 Nov. 2003, and there duly assigned Serial No. 2003-86112.

### BACKGROUND OF THE INVENTION

1. Technical Field

The present invention generally relates to a plasma display panel and a method of manufacturing the same and, in particular, to a plasma display panel and a method of manufacturing the same wherein electrodes are formed on a panel substrate using an offset printing technique.

2. Description of Related Art

Generally, a plasma display panel (PDP) is a display device which displays images using plasma discharge. When voltage is applied to electrodes arranged within discharge spaces of the PDP, the plasma discharge takes place between the electrodes while generating vacuum ultraviolet (VUV) rays. The ultraviolet rays excite phosphors in a predetermined pattern, thereby displaying desired images.

PDPs are largely classified into AC, DC, and hybrid type PDPs. With the AC PDP, address electrodes are formed on a rear substrate in a particular direction, and a dielectric layer is formed on the entire surface of the rear substrate while covering the address electrodes. Barrier ribs are formed in a stripe pattern on the dielectric layer such that each barrier rib is placed between adjacent address electrodes, and red (R), green (G), and blue (B) phosphor layers are formed between the neighboring barrier ribs.

Discharge sustain electrodes are formed on the surface of a front substrate facing the rear substrate in a direction crossing the direction of the address electrodes. The discharge sustain electrodes have a pair of transparent electrodes formed with indium tin oxide (ITO), and bus electrodes formed with a metallic material. A dielectric layer and an MgO protective layer are sequentially formed on the entire surface of the front substrate while covering the discharge sustain electrodes.

The address electrodes formed on the rear substrate and the discharge sustain electrodes formed on the front substrate cross each other, and the crossed regions thereof form discharge cells.

An address voltage is applied between the address electrodes and the discharge sustain electrodes so as to cause the address discharge, and a sustain voltage is applied between the pair of discharge sustain electrodes so as to cause the sustain discharge. At this point, vacuum ultraviolet rays are generated, and they excite the relevant phosphors to emit visible rays through the transparent front substrate, thereby displaying desired images.

With respect to the above-structured PDP, the bus electrodes are formed through photolithography. In the photolithography process, a photosensitive silver (Ag) paste is coated onto the entire surface of the rear substrate to a predetermined thickness, and is patterned through drying, light exposing, and developing steps; or a photosensitive silver (Ag) tape is attached to the entire surface of the rear substrate, and is patterned through light exposing and developing steps.

Particularly, the bus electrodes have a black and white double-layered structure to enhance contrast. For this purpose, a black paste and a white paste are sequentially coated onto the entire surface of the rear substrate, and are exposed to light at the same time. The black electrode layer based on the black paste is formed with a conductive material.

When the bus electrode is formed in the above manner, it involves a constant thickness. However, edge curls (with the firing of the electrode, the edges thereof becoming sharp) are liable to be formed at both lateral sides of the bus electrode. When a dielectric layer is formed on the bus electrode, the edge curls cause the dielectric formation material to be deposited at the lateral sides of the bus electrode, which generates bubble at those points. The incidental bubble generation structure is liable to deteriorate the voltage resistance of the bus electrode. Therefore, the discharge cells at the bus electrode area exhibit abnormalities in their discharge state.

Meanwhile, a black stripe is formed on the front substrate at the non-discharge area thereof to enhance the contrast. The black stripe may be formed together with the bus electrodes, or may be formed separately after the formation of the bus electrodes.

When the black stripe and the bus electrodes are formed together with the same material, the black stripe is electrically conductive as are the bus electrodes. Therefore, when the black stripe is formed in the entire non-discharge area, the neighboring discharge sustain electrodes for discharge cells positioned close to each other are likely to be short circuited. Furthermore, since the black stripe contains a conductive material, the density thereof becomes deteriorated, limiting contrast enhancement.

On the other hand, when the black stripe is separately formed after the formation of the bus electrodes, the printing, drying, light exposing, developing and firing steps for forming the black stripe must be repeated after the printing, drying, light exposing, developing and firing steps for forming the bus electrodes are performed. This involves complicated processing steps and much time consumption, and hence, it is not appropriate for the mass production process.

### SUMMARY OF THE INVENTION

It is an object of the present invention to provide a method of manufacturing a PDP in which electrodes are formed using an offset printing technique to reduce electrode material consumption, and to form a fine and precise electrode pattern.

It is another object of the present invention to provide a method of manufacturing a PDP in which a nonconductive black layer is formed in a non-discharge area with the formation of bus electrodes on the front substrate using an offset printing technique to enhance the contrast in a simplified manner.

It is still another object of the present invention to provide a PDP with improved electrode structure and enhanced contrast.

In one embodiment of the present invention, the PDP includes a first substrate and a second substrate facing each other, and address electrodes formed in parallel on the second substrate. Barrier ribs are arranged between the first and second substrates to define a plurality of discharge cells, and a phosphor layer is formed within each respective discharge cell. The PDP further includes discharge sustain electrodes which have transparent electrodes formed on the first substrate in a direction crossing the address electrodes, and bus electrodes formed on the transparent electrodes while extending in a direction parallel to that of the transparent electrodes. A gap between adjacent transparent electrodes of the discharge cells positioned adjacent to each other in the direction of the address electrodes is filled with a nonconductive opaque-colored layer.

The bus electrode and the nonconductive opaque-colored layer are convex-shaped with a predetermined curvature in the direction of the thickness thereof.

The nonconductive opaque-colored layer partially overlaps with the transparent electrodes. The bus electrodes are positioned close to the nonconductive opaque-colored layer, and the nonconductive opaque-colored layer may partially overlap with the bus electrodes and the transparent electrodes. The bus electrodes are placed on the transparent electrodes and the nonconductive opaque-colored layer.

The bus electrode has a width-direction center placed on the transparent electrode while being electrically connected to the transparent electrode, and has a periphery placed on the nonconductive opaque-colored layer. The bus electrode has an oval-shaped cross section taken perpendicular to the longitudinal direction thereof.

The bus electrode may have one side portion around the width-direction center thereof formed on the transparent electrode, and an opposite side portion which overlaps with the periphery of the nonconductive opaque-colored layer sided with the transparent electrode.

The nonconductive opaque-colored layer may cover the bus electrodes.

The nonconductive opaque-colored layer is based on black, and the bus electrode is formed with an electrode material based on white.

With a method of manufacturing the PDP, a plurality of transparent electrodes with a predetermined pattern are formed on a first substrate such that the transparent electrodes proceed parallel to each other. A gravure groove having a predetermined pattern is filled with a nonconductive opaque-colored paste. The nonconductive opaque-colored paste is transferred from the gravure groove to a printing blanket. The nonconductive opaque-colored paste is transcribed from the printing blanket onto the first substrate such that the paste is targeted at the non-discharge region between the neighboring transparent electrodes. A gravure groove having a predetermined bus electrode pattern is filled with a bus electrode paste. The bus electrode paste is transferred from the gravure groove to the printing blanket. The bus electrode paste is transcribed from the printing blanket onto the transparent electrodes formed on the first substrate. The nonconductive opaque-colored paste pattern and the bus electrode paste pattern formed on the first substrate are dried and fired. A dielectric layer is formed on the first substrate such that the dielectric layer covers the transparent electrodes, the bus electrodes, and the nonconductive opaque-colored layer. A second substrate is aligned with the first substrate such that the first and second substrates face each other, and a discharge gas is injected between the first and second substrates. The substrates are then sealed with respect to each other.

The gap between adjacent transparent electrodes on the first substrate corresponding to the non-discharge region, is filled with the nonconductive opaque-colored paste. The coated nonconductive opaque-colored paste is overlapped with the periphery of the transparent electrodes.

The bus electrode paste is overlapped with the nonconductive opaque-colored paste. The bus electrode paste may completely cover the nonconductive opaque-colored paste.

The bus electrode paste may partially overlap the periphery of the nonconductive opaque-colored paste, and partially overlap the transparent electrodes.

The bus electrode paste may be formed on the transparent electrodes such that the bus electrode paste is positioned close to the periphery of the nonconductive opaque-colored paste that partially overlaps the transparent electrodes.

It is possible that the bus electrodes are formed on the transparent electrodes, and that the nonconductive opaque-colored paste covers the bus electrodes formed on the transparent electrodes.

The nonconductive opaque-colored paste is based on black, and the bus electrode paste is formed with an electrode material based on white.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial exploded perspective view of a PDP according to a first embodiment of the present invention;

FIG. 2 is a sectional view of the PDP of FIG. 1 according to the first embodiment of the present invention, illustrating the structure thereof where discharge sustain electrodes and a black pattern are formed on a first substrate;

FIGS. 3A to 3E sequentially illustrate the electrode printing steps using an offset printing technique;

FIG. 4 schematically illustrates the process of forming a groove at a gravure plate, filling the groove with a paste, and transcribing it onto a glass substrate;

FIG. 5 schematically illustrates the process of forming a groove at a gravure roll, filling the groove with a paste, and transcribing it onto a glass substrate;

FIG. 6 is a sectional view of a PDP according to a second embodiment of the present invention, illustrating the structure thereof wherein discharge sustain electrodes and a black pattern are formed on a first substrate;

FIG. 7 is a sectional view of a PDP according to a third embodiment of the present invention, illustrating the structure thereof wherein discharge sustain electrodes and a black pattern are formed on a first substrate;

FIG. 8 is a sectional view of a PDP according to a fourth embodiment of the present invention, wherein discharge sustain electrodes and a black pattern are formed on a first substrate;

FIG. 9 is an exploded perspective view of an AC-type PDP; and

FIG. 10 illustrates the structure of the PDP where bus electrodes and a black stripe are formed on a front substrate through photolithography.

### DETAILED DESCRIPTION OF PREFERRED EMBODIMENTS

The present invention will be described more fully hereinafter with reference to the accompanying drawings, in which preferred embodiments of the invention are shown.

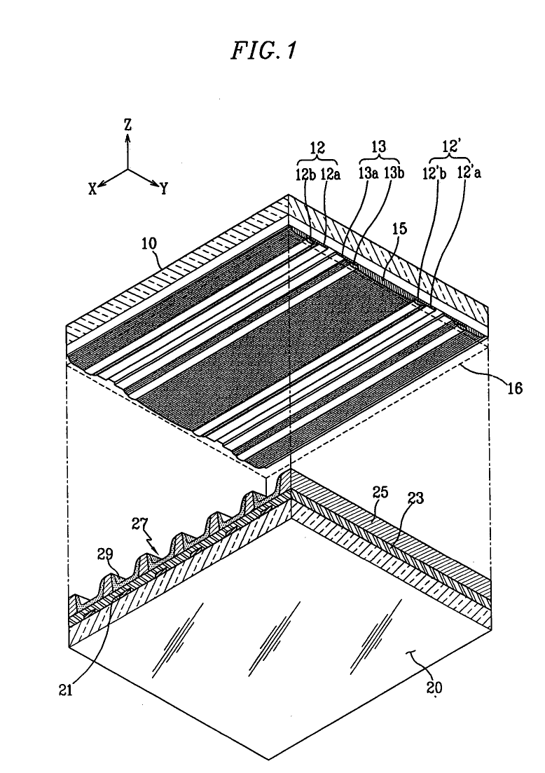

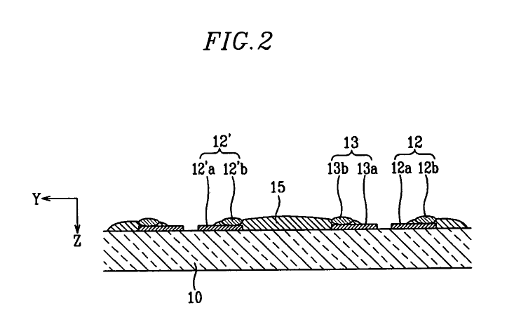

FIG. 1 is a partial exploded perspective view of a PDP according to a first embodiment of the present invention, and FIG. 2 is a sectional view of the PDP illustrating the structure thereof wherein discharge sustain electrodes and a black pattern are formed together on a first substrate.

As shown in the drawings, the PDP includes first and second substrates 10 and 20, respectively, spaced apart from each other by a predetermined distance while facing each other, and barrier ribs 25 arranged between the first substrate 10 and the second substrate 20 to define a plurality of discharge cells 27 in which plasma discharge take place. Discharge sustain electrodes 12, 13 and 12′ are formed on the first substrate 10, and address electrodes 21 are formed on the second substrate 20. Red (R), blue (B), and green (G) phosphors are coated onto the inner surface of the discharge cells 27 to form phosphor layers 29.

Specifically, a plurality of address electrodes 21 are formed on the surface of the second substrate 20 facing the first substrate 10 in a certain direction (the Y-axis direction of the drawing). The address electrodes 21 are spaced apart from each other by a predetermined distance while extending parallel to each other. A dielectric layer 23 is formed on the second substrate 20 while covering the address electrodes 21.

A plurality of discharge sustain electrodes 12, 13 and 12′ are formed on the first substrate 10 in a direction crossing the address electrodes 21 (the X-axis direction in FIG. 1) while extending parallel to each other, and the discharge cell wherein the pair of discharge sustain electrodes face each other forms a pixel. The pair of discharge sustain electrodes 12 and 13 function as an X electrode (common electrode) and a Y electrode (scan electrode), and the discharge sustain electrodes 12, 13 and 12′ further comprise transparent electrodes 12a, 13a and 12′a, respectively, and bus electrodes 12b, 13b and 12′b, respectively. The transparent electrodes 12a, 13a, and 12′a may be formed with a stripe shape, or may be separately formed at the respective discharge cells 27 with a protrusion shape.

Meanwhile, bus electrodes 12b, 13b, and 12′b are formed on the transparent electrodes 12a, 13a and 12′a, respectively, while extending parallel thereto, and are biased from the widthwise center to one side portion thereof. In particular, with the area where a pair of transparent electrodes 12a and 13a correspondingly form a discharge cell, the bus electrodes 12b and 13b are arranged on the respective transparent electrodes 12a and 13a such that they are placed at the opposite side portions of the transparent electrodes, and distant from each other. The bus electrodes 12b, 13b and 12′b are formed with a silver (Ag) electrode material, and are white-colored. The bus electrodes compensate for the high resistance of the ITO electrode for the transparent electrodes 12a, 13a and 12′a so as to reduce the voltage drop on the discharge sustain electrodes.

A nonconductive black layer 15 is formed at the region between adjacent transparent electrodes 13a and 12′a placed within the different discharge cells adjacent to each other in the direction of the address electrodes (the Y-axis direction of the drawing), corresponding to the non-discharge area (referred to hereinafter simply as the ‘non-discharge region’). The nonconductive black layer 15 is overlapped with the transparent electrodes 12a, 13a and 12′a. That is, the black layer 15 occupies all the non-discharge region, and is partially overlapped with the portion of the transparent electrodes beside the non-discharge region.

The bus electrodes 12b, 13b and 12′b are placed on the transparent electrodes 12a, 13a and 12′a as well as on the non-conductive black layer 15. That is, the width-direction center of the bus electrodes is placed on the transparent electrodes 12a, 13a and 12′a while being electrically connected thereto, and the periphery thereof is on the nonconductive black layer 15. For this purpose, the bus electrodes 12b, 13b and 12′b have an oval-shaped cross section which is taken perpendicular to the longitudinal direction thereof. The bus electrodes may be formed using an offset printing technique.

As the nonconductive black layer 15 is formed with a nonconductive material to enhance the contrast, it involves sufficient intensity of opaqueness. Accordingly, the black layer 15 can be formed in the entire non-discharge region without incurring a short circuit between the neighboring discharge sustain electrodes, thereby exerting a reliable contrast enhancement effect.

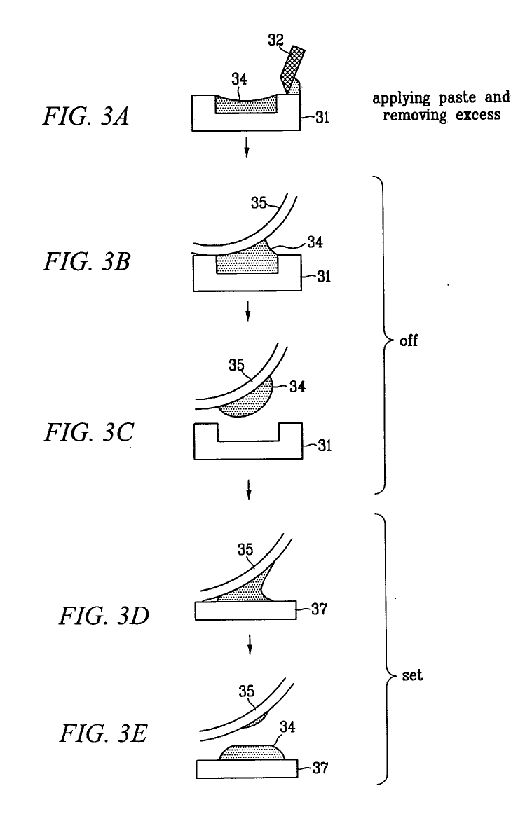

A method of forming electrodes on a substrate for the PDP using an offset printing technique will be now explained with reference to FIGS. 3 to 5.

FIGS. 3A to 3E sequentially illustrate the electrode printing steps using an offset printing technique.

As shown in FIG. 3A, a groove is formed in a plate 31 with a target electrode pattern, and is filled with an electrode paste 34. Note that the electrode paste 34, which overflows on the grooved plate 31, is removed using a blade 32.

Thereafter, as shown in FIGS. 3B and 3C, the electrode paste 34 filled within the groove of the grooved plate 31 is transferred to a printing blanket 35. As shown in FIGS. 3D and 3E, the electrode paste 34 is then transcribed from the printing blanket 35 onto a glass substrate 37, followed by drying and firing it.

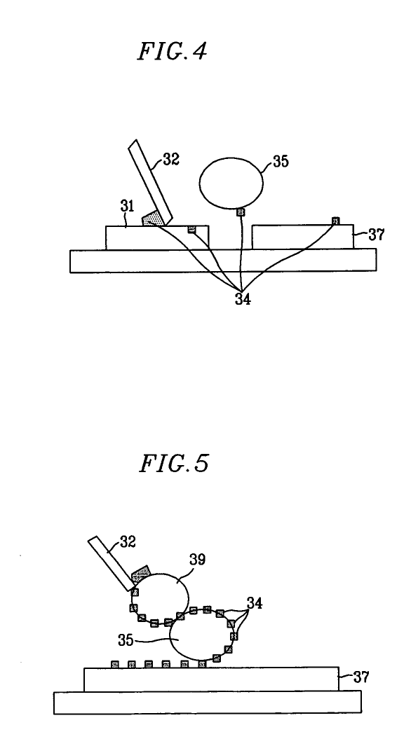

FIG. 4 illustrates the process of forming a groove in a gravure plate, filling the groove with a paste, and transcribing the paste onto a glass substrate, and FIG. 5 illustrates the process of forming a groove in a gravure roll, filling the groove with a paste, and transcribing the paste onto a glass substrate.

A bus electrode pattern and a nonconductive black layer pattern are formed by making a groove in a gravure plate 31 or in a gravure roll 39, filling it with a paste, transferring the paste to a blanket 35, and transcribing it onto a glass substrate 37.

The offset printing technique for forming bus electrodes and a nonconductive black layer on a substrate for the PDP will be now explained more specifically.

First, referring to FIG. 2, a plurality of transparent electrodes 12a, 13a and 12′a with a predetermined pattern are formed on the first substrate 10 in such a manner that they extend in parallel with each other.

Thereafter, the gravure groove with a predetermined pattern is filled with a nonconductive black paste. The pattern of the gravure groove is formed based on the shape of the previously formed transparent electrodes 12a, 13a and 12′a such that the target layer covers the non-discharge region while partially overlapping portions of the transparent electrodes 12a, 13a and 12′a. The gravure groove may be selectively formed in a gravure plate 31 (FIG. 4) or a gravure roll 39 (FIG. 5). After the filling of the groove with paste, overflowing paste is removed using a blade 32 (FIG. 3A).

The nonconductive black paste filled within the gravure groove is transferred to a printing blanket 35 (FIGS. 3B and 3C).

The nonconductive black paste is then transcribed from the printing blanket 35 onto the first substrate 10 (FIG. 2). At this point, the nonconductive black paste is targeted at the non-discharge region on the first substrate 10 while partially overlapping the transparent electrodes 12a, 13a and 12′a.

After the coating of the nonconductive black paste, a bus electrode paste is coated onto the substrate 10. The method of coating the bus electrode paste is similar to that of coating the nonconductive black paste.

That is, the gravure groove with a predetermined bus electrode pattern is filled with a bus electrode paste. At this time, in view of the shape of the previously formed transparent electrodes 12a, 13a and 12′a, and the nonconductive black layer 15, the bus electrodes 12b, 13b and 12′b are formed on the transparent electrodes 12a, 13a and 12′a so as to extend parallel thereto.

Specifically, in order to form the bus electrodes 12b, 13b and 12′b, it is preferable that the bus electrode paste completely cover the nonconductive black paste coated on the first substrate 10. As the nonconductive black paste has some fluidity before drying, it is extruded to the side portions around the center (widthwise) of the bus electrode so that the bus electrode paste directly contacts the transparent electrode while being electrically connected thereto.

The bus electrode paste within the gravure groove is transferred to a printing blanket 35 (FIGS. 3B and 3C), and is then transcribed from the printing blanket 35 onto the first substrate 10 (FIG. 2).

The nonconductive black paste pattern and the bus electrode paste pattern are then dried and fired. A dielectric layer is formed on the first substrate 10 such that it covers the transparent electrodes 12a, 13a and 12′a, the bus electrodes, and the nonconductive black layer 15, and a protective layer is formed on the dielectric layer, thereby completing the front substrate for the PDP. When the bus electrodes and the nonconductive black layer 15 are formed using an offset printing technique, the contrast-enhancement black layer and the bus electrodes 12b, 13b and 12′b can be formed in a simplified manner. Since it is not required that a part of the bus electrode be formed as a black electrode, excellent electrical conductivity can be maintained. At this point in the process, the bus electrode or the nonconductive black layer 15 is convex-shaped with a predetermined curvature in the direction of the thickness thereof.

The front substrate is aligned to a rear substrate, made through a separate process, such that they face each other, and a discharge gas is injected between the substrates. The substrates are then sealed to each other, thereby completing the PDP.

The nonconductive paste used in forming the nonconductive black layer 15 is not limited to a black-colored one paste. Rather, other nonconductive opaque-colored pastes that are well adapted for a contrast enhancement purpose may be used. Furthermore, a white electrode material, such as silver (Ag), can be used as the bus electrode paste for forming the bus electrodes, but a different colored material may be used for that purpose provided that it has reasonable electrical conductivity.

PDPs according to the second to fourth embodiments of the present invention will be now explained in detail. With these PDPs, the bus electrodes 12b, 13b and 12′b and the nonconductive black layer 15 may be formed using the offset printing technique.

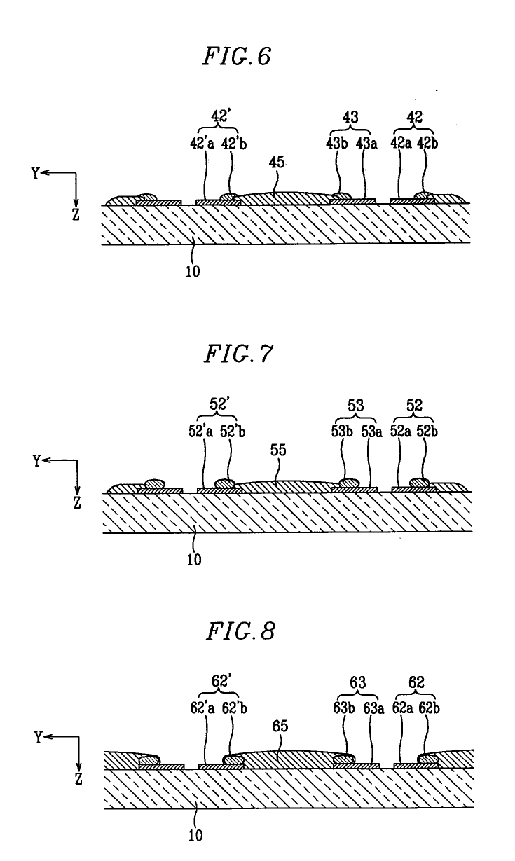

FIG. 6 is a sectional view of a PDP according to the second embodiment of the present invention, and illustrates the structure thereof wherein discharge sustain electrodes and a black pattern are formed together on the first substrate.

As shown in FIG. 6, a nonconductive black layer 45 occupies the entire non-discharge region while partially overlapping with the transparent electrodes 42a, 43a and 42′a. That is, the black layer 45 covers the non-discharge region while partially overlapping with the portions of the transparent electrodes 42a, 43a and 42′a beside the non-discharge region.

The bus electrodes 42b, 43b, and 42′b are placed on the transparent electrodes 42a, 43a and 42′a as well as on the nonconductive black layer 45, as in the structure related to the first embodiment of the invention. However, in this embodiment, one side of the bus electrodes 42b, 43b, and 42′b are placed on the transparent electrodes 42a, 43a and 42′a while being electrically connected thereto, and the other side of the bus electrodes 42b, 43b and 42′b are overlapped with the periphery of the nonconductive black layer 45 that partially overlaps the transparent electrodes 42a, 43a and 42′a.

FIG. 7 is a sectional view of a PDP according to a third embodiment of the present invention, and illustrates the structure thereof where discharge sustain electrodes and a black pattern are formed together on the first substrate.

As shown in FIG. 7, a nonconductive black layer 55 occupies the entire non-discharge region while partially overlapping the transparent electrodes 52a, 53a and 52′a. That is, the black layer 55 covers the non-discharge region and partially overlaps portions of the transparent electrodes beside 52a, 53a and 52′a the non-discharge region.

The bus electrodes 52b, 53b and 52′b are placed on the transparent electrodes 52a, 53a, and 52′a while extending parallel thereto, and are positioned close to the nonconductive black layer 55 that partially overlaps the transparent electrodes 52a, 53a and 52′a.

FIG. 8 is a sectional view of a PDP according to a fourth embodiment of the present invention, and illustrates the structure thereof where discharge sustain electrodes and a black pattern are formed together on the first substrate.

As shown in FIG. 8, a nonconductive black layer 65 occupies the entire non-discharge region while partially overlapping the transparent electrodes 62a, 63a and 62′a. In this embodiment, the nonconductive black layer 65 covers the bus electrodes 62b, 63b and 62′b.

For this purpose, a bus electrode paste is first coated onto the transparent electrodes 62a, 63a and 62′a, and a nonconductive black paste is coated thereon.

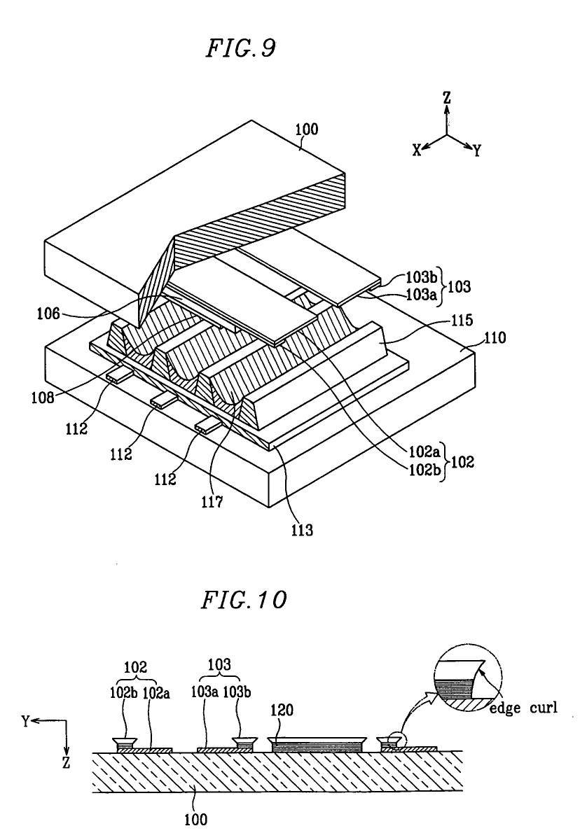

FIG. 9 is an exploded perspective view of an AC-type PDP, while FIG. 10 illustrates the structure of the PDP wherein bus electrodes and a black stripe are formed on a front substrate through photolithography.

As shown in FIG. 9, in the AC PDP, address electrodes 112 are formed on a rear substrate 110 in a particular direction (in the X-axis direction in FIG. 9), and a dielectric layer 113 is formed on the entire surface of the rear substrate 110 while covering the address electrodes 112. Barrier ribs 115 are formed in a stripe pattern on the dielectric layer 113 such that each barrier rib 115 is positioned between adjacent address electrodes 112, and red (R), green (G), and blue (B) phosphor layers 117 are formed between the adjacent barrier ribs 115.

Discharge sustain electrodes 102 and 103 are formed on the surface of a front substrate 100 facing the rear substrate 110 in a direction crossing the address electrodes 112 (the Y-axis direction in FIG. 9). The discharge sustain electrodes 102 and 103 have a pair of transparent electrodes 102a and 103a, respectively, formed with indium tin oxide (ITO), and bus electrodes 102b and 103b, respectively, formed with a metallic material. A dielectric layer 106 and an MgO protective layer 108 are sequentially formed on the entire surface of the front substrate 100 while covering the discharge sustain electrodes 102 and 103.

The address electrodes 112 formed on the rear substrate 110 and the discharge sustain electrodes 102 and 103 formed on the front substrate 100 cross each other, and the crossed regions thereof form discharge cells.

An address voltage Va is applied between the address electrodes 112 and the discharge sustain electrodes 102 and 103 so as to cause the address discharge, and sustain voltage Vs is applied between the pair of discharge sustain electrodes 102 and 103 so as to cause the sustain discharge. At this point, vacuum ultraviolet rays are generated, and they excite the relevant phosphors to emit visible rays through the transparent front substrate 100, thereby displaying desired images.

With the above-structured PDP, the bus electrodes 102b and 103b are formed through photolithography. In the photolithography process, a photosensitive silver (Ag) paste is coated onto the entire surface of the rear substrate 110 to a predetermined thickness, and is patterned through drying, light exposing and developing steps; or a photosensitive silver (Ag) tape is attached to the entire surface of the rear substrate 110, and is patterned through light exposing and developing steps.

Particularly, the bus electrodes 102b and 103b have a black and white double-layered structure to enhance contrast. For this purpose, a black paste and a white paste are sequentially coated onto the entire surface of the rear substrate 110, and are exposed to light at the same time. The black electrode layer based on the black paste is formed with a conductive material.

When the bus electrodes 102b and 103b are formed in the above way, it involves a constant thickness. However, as shown in FIG. 10, edge curls (with the firing of the electrode, the edges thereof become sharp) are liable to be formed at both lateral sides of the bus electrodes 102b and 103b. When a dielectric layer is formed on the bus electrodes 102b and 103b, the edge curls cause the dielectric formation material to be deposited on the lateral sides of the bus electrodes, which generates a bubble at those points. The incidental bubble generation structure is liable to cause the voltage resistance of the bus electrodes to deteriorate. Therefore, the discharge cells at the bus electrode areas exhibit abnormalities in their discharge state.

Meanwhile, as shown in FIG. 10, a black stripe 120 is formed in the non-discharge area of the front substrate 100 so as to enhance the contrast. The black stripe 120 may be formed together with the bus electrodes 102 and 103, or separately after the formation of the bus electrodes 102 and 103.

When the black stripe 120 and the bus electrodes 102 and 103 are formed together with the same material, the black stripe 120 is electrically conductive as are the bus electrodes 102 and 103. Therefore, when the black stripe 120 is formed in the entire non-discharge area, the adjacent discharge sustain electrodes for the discharge cells positioned close to each other are liable to be short circuited. Furthermore, since the black stripe 120 contains a conductive material, the density thereof becomes deteriorated, limiting contrast enhancement.

As described above, with the inventive method of manufacturing a PDP, the contrast enhancement black layer and the bus electrodes are formed in a simplified manner, and it is not necessary to partially form the bus electrode with a black electrode, thereby maintaining extremely good electrical conductivity.

Furthermore, with the inventive PDP, a nonconductive material is used to enhance the contrast, thereby obtaining sufficient intensity, and a black layer is formed in the entire non-discharge region without incurring a short circuit between the adjacent discharge sustain electrodes, thereby producing a reliable contrast enhancement.

Although preferred embodiments of the present invention have been described in detail above, it should be clearly understood that many variations and/or modifications of the basic inventive concept taught herein will appear to those skilled in the art but will still fall within the spirit and scope of the present invention, as defined in the appended claims.

1. A plasma display panel, comprising:
a first substrate and a second substrate facing each other;
address electrodes formed on the second substrate and extending parallel to each other;
barrier ribs disposed between the first and second substrates so as to define a plurality of discharge cells;
a phosphor layer formed within each of the respective discharge cells; and
discharge sustain electrodes including transparent electrodes formed on the first substrate in a direction crossing the address electrodes, and bus electrodes formed on the transparent electrodes and extending parallel to the transparent electrodes,
wherein a gap between adjacent transparent electrodes of the discharge cells positioned close to each other in the direction of the address electrodes is filled with a nonconductive opaque-colored layer.

2. The plasma display panel of claim 1, wherein each of the bus electrodes is convex-shaped with a predetermined curvature extending in a direction of a thickness thereof.

3. The plasma display panel of claim 1, wherein the nonconductive opaque-colored layer is convex-shaped with a predetermined curvature extending in a direction of a thickness thereof.

4. The plasma display panel of claim 1, wherein the nonconductive opaque-colored layer partially overlaps the transparent electrodes.

5. The plasma display panel of claim 4, wherein the bus electrodes are positioned close to the nonconductive opaque-colored layer.

6. The plasma display panel of claim 4, wherein the nonconductive opaque-colored layer partially overlaps with the bus electrodes and the transparent electrodes.

7. The plasma display panel of claim 6, wherein the bus electrodes are disposed on the transparent electrodes and the nonconductive opaque-colored layer.

8. The plasma display panel of claim 7, wherein each of the bus electrodes has a widthwise center positioned on a respective one of the transparent electrodes while being electrically connected to the respective one of the transparent electrodes, and a periphery placed on the nonconductive opaque-colored layer.

9. The plasma display panel of claim 8, wherein each of the bus electrodes has an oval-shaped cross-section extending perpendicular to a longitudinal direction thereof.

10. The plasma display panel of claim 7, wherein each of the bus electrodes has one side portion around a widthwise center thereof formed on a corresponding one of the transparent electrodes, and an opposite side portion overlapping a periphery of the nonconductive opaque-colored layer adjacent to the corresponding one of the transparent electrodes.

11. The plasma display panel of claim 6, wherein the nonconductive opaque-colored layer covers the bus electrodes.

12. The plasma display panel of claim 1, wherein the nonconductive opaque-colored layer is based on black.

13. The plasma display panel of claim 1, wherein each of the bus electrodes is formed with an electrode material based on white.

14. The plasma display panel of claim 1, wherein the nonconductive opaque-colored layer is formed using an offset printing technique.

15. The plasma display panel of claim 1, wherein each of the bus electrodes is formed using an offset printing technique.

16. A method of manufacturing a plasma display panel, the method comprising the steps of:
forming a plurality of transparent electrodes with a predetermined pattern on a first substrate such that the transparent electrodes extend parallel to each other;
filling a gravure groove having a predetermined pattern with a nonconductive opaque-colored paste;
transferring the nonconductive opaque-colored paste from the gravure groove to a printing blanket;
transcribing the nonconductive opaque-colored paste from the printing blanket onto the first substrate such that the paste is targeted at a non-discharge region between adjacent transparent electrodes;
filling a gravure groove having a predetermined bus electrode pattern with a bus electrode paste;
transferring the bus electrode paste from the gravure groove to the printing blanket;
transcribing the bus electrode paste from the printing blanket onto the transparent electrodes formed on the first substrate;
drying and firing a nonconductive opaque-colored paste pattern and a bus electrode paste pattern formed on the first substrate;
forming a dielectric layer on the first substrate such that the dielectric layer covers the transparent electrodes, the bus electrodes, and a nonconductive opaque-colored layer; and
aligning a second substrate with the first substrate such that the first and second substrates face each other, injecting a discharge gas between the first and second substrates, and sealing the first and second substrates to each other.

17. The method of claim 16, wherein a gap between adjacent transparent electrodes on the first substrate corresponding to the non-discharge region is filled with the nonconductive opaque-colored paste.

18. The method of claim 17, wherein the nonconductive opaque-colored paste overlaps with a periphery of the transparent electrodes.

19. The method of claim 18, wherein the bus electrode paste overlaps with the nonconductive opaque-colored paste.

20. The method of claim 19, wherein the bus electrode paste is disposed on the nonconductive opaque-colored paste in its entirety.

21. The method of claim 19, wherein the bus electrode paste partially overlaps a periphery of the nonconductive opaque-colored paste, and partially overlaps the transparent electrodes.

22. The method of claim 16, wherein the bus electrode paste is formed on the transparent electrodes such that the bus electrode paste is positioned close to a periphery of the nonconductive opaque-colored paste that partially overlaps the transparent electrodes.

23. The method of claim 16, wherein the bus electrodes are formed on the transparent electrodes, and the nonconductive opaque-colored paste covers the bus electrodes formed on the transparent electrodes.

24. The method of claim 16, wherein the nonconductive opaque-colored paste is based on black.

25. The method of claim 16, wherein the bus electrode paste is formed with an electrode material based on white.
